(19) United States
(12) Patent Application Publication
(10) Pub. No.: US 2004/0109033 A1
(43) Pub. Date: Jun. 10, 2004

(54) Selecting functions via a graphical user interface

(75) Inventors: Chris Vienneau, Montreal (CA); Juan Pablo Di Lelle, Montreal (CA); Michiel Schriever, Montreal (CA)

Correspondence Address: GATES & COOPER LLP, HOWARD HUGHES CENTER, 6701 CENTER DRIVE WEST, SUITE 1050, LOS ANGELES, CA, 90045, US

(73) Assignee: AUTODESK CANADA INC.

(21) Appl. No.: 10/620,391

(22) Filed: Jul. 16, 2003

(30) Foreign Application Priority Data
Jul. 19, 2002 (GB) 02 16 824.3

(51) Int. Cl. G09G 5/00

(52) U.S. Cl. 345/863

(57) ABSTRACT

Apparatus for processing image data is provided, comprising processing means, storage means, display means and stylus-like manually operable input means, wherein said processing means is configured to perform functions upon image data in response to an operator manually selecting a function from a function menu; said processing means responds to a first user-generated input command so as to display a plurality of function gates at a cursor position; movement of the stylus-like manually operable input means so as to move said cursor through one of said function gates results in a related menu being displayed; and manual selection of a function from said displayed menu results in the selected function being performed upon said image data.

### CROSS REFERENCE TO RELATED APPLICATIONS

This application claims the benefit under 35 U.S.C. § 119 of the following co-pending and commonly-assigned patent application, which is incorporated by reference herein:

United Kingdom Patent Application Number 02 16 824.3, filed on Jul. 19, 2003, by Chris Vienneau, Juan Pablo Di Lelle, and Michiel Schriever, entitled “SELECTING FUNCTIONS VIA A GRAPHICAL USER INTERFACE”.

This application is related to the following commonly-assigned United States patents, which are incorporated by reference herein:

U.S. Pat. No. 5,892,506, filed on Mar. 18, 1996 and issued on Apr. 6, 1999, by David Hermanson, entitled “MULTIRACK ARCHITECTURE FOR COMPUTER-BASED EDITING OF MULTIMEDIA SEQUENCES”, Attorney's Docket Number 30566.151-US-01;

U.S. Pat. No. 5,786,824, filed on Apr. 10, 1996 and issued on Jul. 28,1998, by Benoit Sevigny, entitled “PROCESSING IMAGE DATA”, Attorney's Docket Number 30566.170-US-01; and

U.S. Pat. No. 6,269,180, filed on Apr. 9, 1997 and issued on Jul. 31, 2001, by Benoit Sevigny, entitled “METHOD AND APPARATUS FOR COMPOSITING IMAGES”, Attorney's Docket Number 30566.180-US-01;

### BACKGROUND OF THE INVENTION

1. Field of the Invention

The present invention relates to apparatus for processing image data.

2. Description of the Related Art

Systems for processing image data, having a processing unit, storage devices, a display device and a stylus-like manually operable input device (such as a stylus and touchtablet combination) are shown in U.S. Pat. Nos. 5,892,506; 5,786,824 and 6,269,180 all assigned to the present Assignee. In these aforesaid systems, it is possible to perform many functions upon stored image data in response to an operator manually selecting a function from a function menu.

Recently, in such systems as “FIRE” and “INFERNO”, licensed by the present Assignee, the number of functions that may be performed have increased significantly. In addition, for example, there has been a tendency towards providing functions for special effects, compositing and editing on the same platform.

Function selection is often done via graphical user interfaces in which menus are displayed from which a selection may be made. A function selection using a menu is achieved by moving a cursor over to a selection position within the menu by operation of the stylus. The particular function concerned is selected by placing the stylus into pressure; an operation logically similar to a mouse click. Menus of this type are used in systems where stylus-like input devices are preferred, in preference to pulldown menus.

In addition to there being a trend towards increasing the level of functionality provided by digital image processing systems, there has also been a trend towards manipulating images of higher definition. Initially, many systems of this type were designed to manipulate standard broadcast television images such as NTSC or PAL. With images of this type, it is possible to display individual frames on a high definition monitor such that the displayed images take up a relatively small area of the monitor thereby leaving other areas of the monitor for displaying menus etc. Increasingly, digital techniques are being used on high definition video images or images scanned from cinematographic film. Such images have a significantly higher pixel definition. Consequently, even when relatively large monitors are used, there may be very little additional area for the display of menus.

Furthermore, operators and artists are under increasing pressure to speed up the rate at which work is finished. Being able to work with systems of this type quickly and efficiently is not facilitated if complex menu structures are provided or manipulation tools are included that are not intuitive to the way artists work.

### BRIEF SUMMARY OF THE INVENTION

According to a first aspect of the present invention, there is provided apparatus for processing image data, comprising processing means, storage means, display means and stylus-like manually operable input means, wherein said processing means is configured to perform functions upon image data in response to an operator manually selecting a function from a function menu; said processing means responds to a first user-generated input command so as to display a plurality of function gates at a cursor position; movement of the stylus-like manually operable input means so as to move said cursor through one of said function gates results in a related menu being displayed; and manual selection of a function from said displayed menu results in the selected function being performed upon said image data.

### BRIEF DESCRIPTION OF THE SEVERAL VIEWS OF THE DRAWINGS

FIG. 1 shows a system for processing image data;

FIG. 2 shows details the computer system shown in FIG. 1;

FIG. 3 shows illustrates the display of the prior art;

FIG. 4 shows the display of FIG. 3 with graphically displayed menus as is known in the prior art;

FIG. 5 shows an example of a scene graph defining how a complex scene is rendered;

FIG. 6 is the monitor of FIG. 1 displaying a high definition image;

FIG. 7 shows a portion of the image shown in FIG. 6 with user interface gates;

FIG. 8 shows an abstracted view of the gates shown in FIG. 7;

FIG. 9 shows the high definition image of FIG. 6 with an overlaid upper menu;

FIG. 10 shows the high definition image of FIG. 6 with a lower menu;

FIG. 11 shows the high definition of FIG. 6 with a menu to the left;

FIG. 12 shows the high definition image of FIG. 6 with a menu to the right;

FIG. 13 identifies operations performed by the processing unit shown in FIG. 2;

FIG. 14 details procedures identified in FIG. 13;

FIG. 15 details procedures identified in FIG. 14;

FIG. 16 details procedures identified in FIG. 15;

FIG. 17 identifies a first alternative embodiment of the present invention;

FIG. 18 identifies further alternative embodiments of the present invention.

An embodiment of the invention will now be described by way of example only with reference to the above drawings.

### DETAILED DESCRIPTION

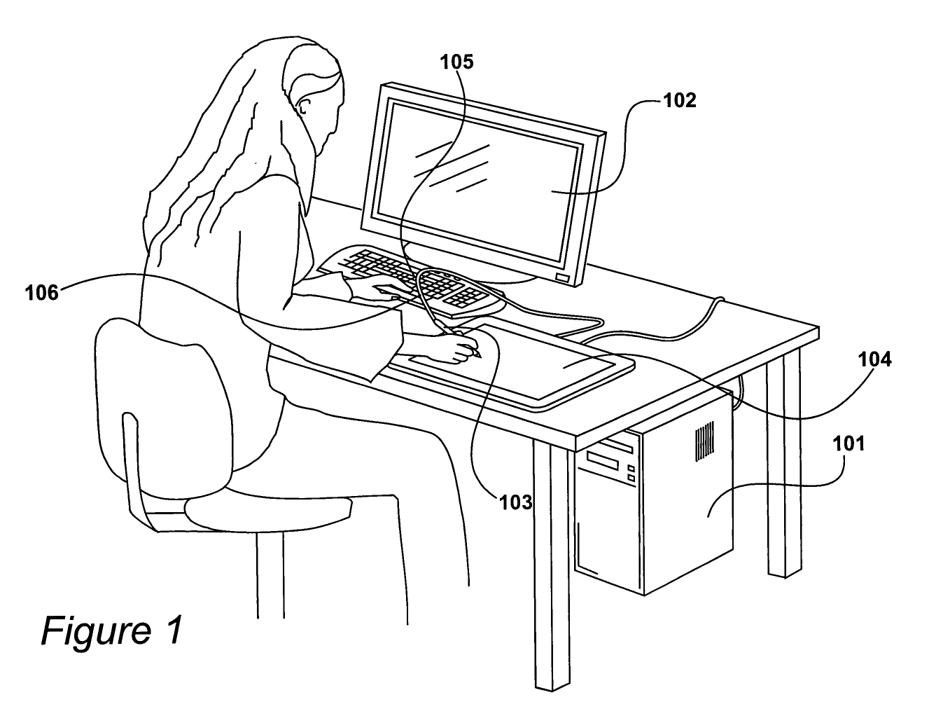

FIG. 1

Apparatus for processing image data is illustrated in FIG. 1. In this example a computer system 101 supplies output signals to a visual display unit 102. The visual display unit 102 displays images, menus and a cursor, and movement of said cursor is controlled in response to manual operation of a stylus 103 upon a touch table 104. In addition, input data is also supplied to the computer system 101 via a keyboard 105. Keyboard 105 is of a standard alpha numeric layout and includes a spacebar 106. Manual operation of the spacebar 106 provides a first input command in a preferred embodiment resulting in a selection device being displayed at the cursor position. The selection device identifies a plurality of function types (for example four) each having an associated displayable menu. In response to a second input command, preferably received from the stylus 103, the cursor is moved over one of the identified function types. Thereafter, having moved the cursor over a displayed type, the aforesaid menu associated with the function type over which the cursor has been moved is displayed. In this way, a user is given rapid access to a menu of interest without said menu being continually displayed over the working area of the VDU 102.

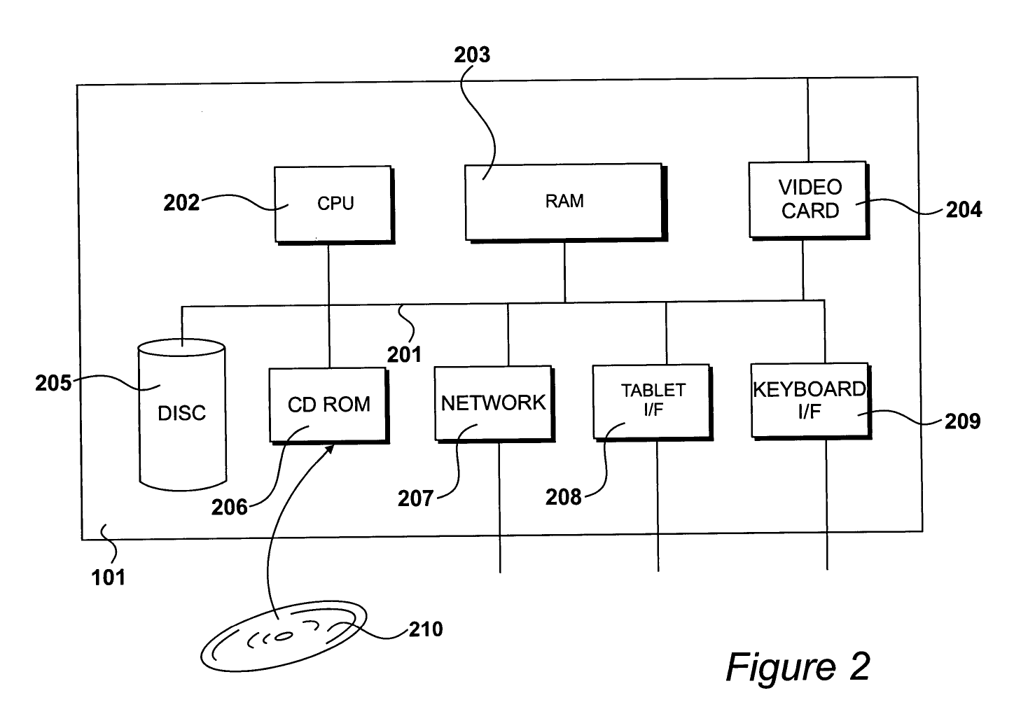

FIG. 2

Computer system 101 is illustrated in FIG. 2. System bus 201 provides communication between a central processing unit 202, random access storage devices 203, a video card 204, disk storage 205, CD ROM reader 206, a network card 207, a tablet interface card 208 and a keyboard interface card 209. Typically, the central processing unit may be an Intel based processor operating under the Windows operating system. Program instructions for the central processing unit 202 are read from the random access memory device at 203. Program instructions are preferably received via a CD ROM 210 (or similar computer-readable medium) for installation within the storage system of disk drive 205 via the CD ROM reader 206.

Network card 204 supplies output signals to monitor 102 with input signals from the tablet 104 being received via a tablet interface 208 and input signals from keyboard 105 being received via the keyboard interface 209. Network interface 207 allows the system to exchange files with a server or other networked stations.

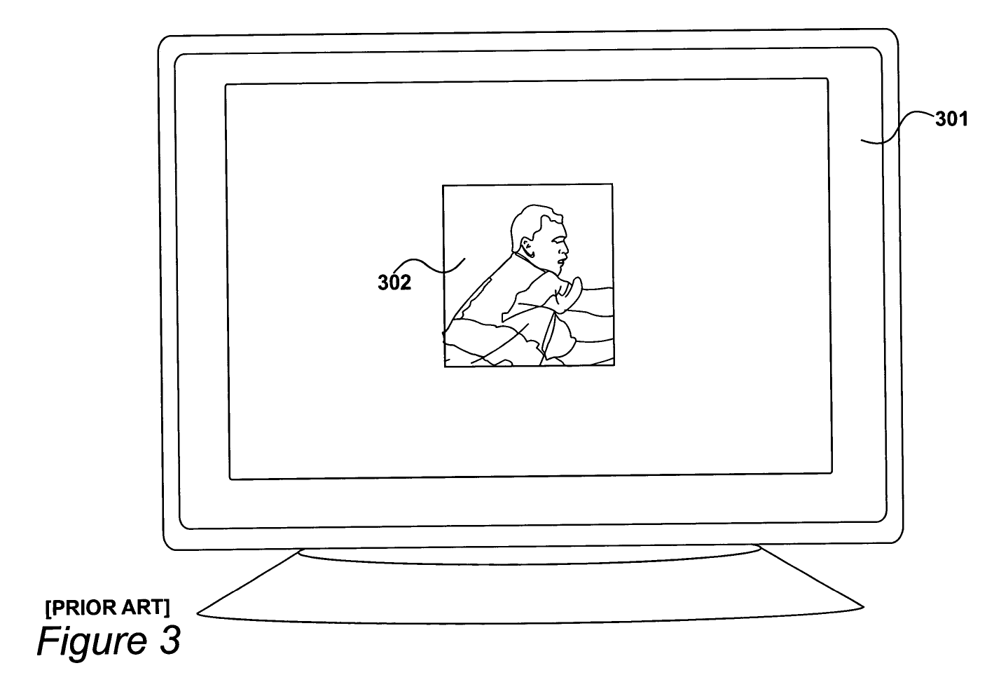

FIG. 3

A monitor 301, of a prior art system and not that shown in FIG. 1, is illustrated in FIG. 3. The monitor is displaying a video image 302 consisting of a plurality of frames played over a period of time at standard broadcast definition. The monitor has a substantially higher definition, thereby ensuring that there is plenty of space around the image 302 for graphical interfaces to be displayed. The skilled reader will understand that it is the entire system that is prior art and not specifically the high-definition monitor. A similar monitor could be used in an embodiment of the present invention.

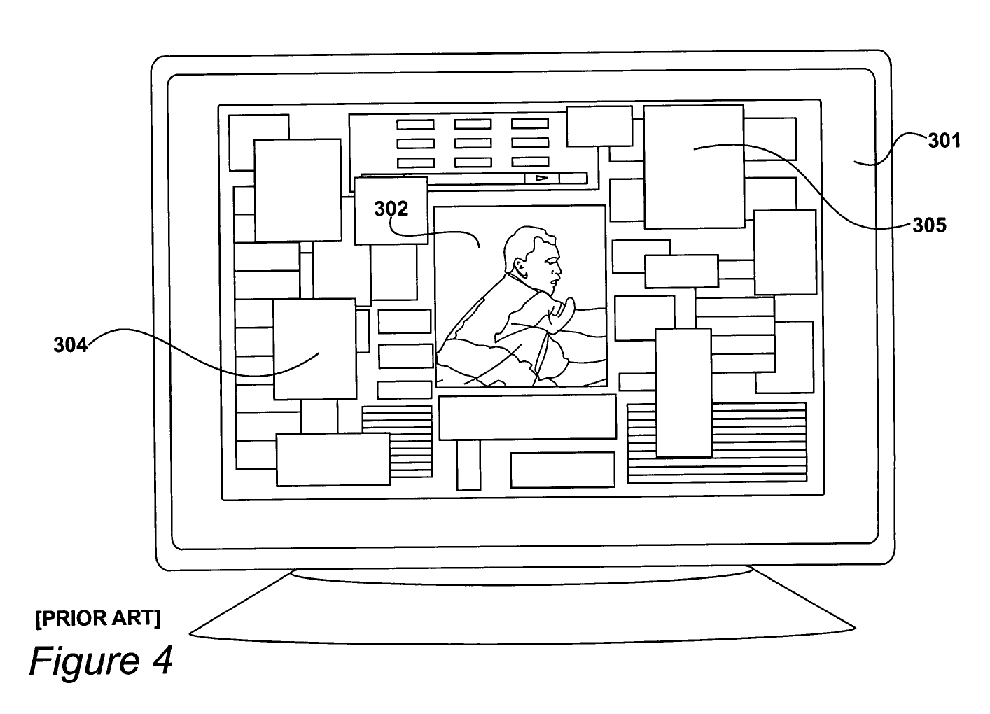

FIG. 4

Monitor 301 is shown in FIG. 4 with a plurality of menus, such as menu 304 and menu 305, displayed around video image 302. In this way, many control functions may be selected by appropriate operation of a stylus upon a touch-tablet. A function of interest is selected by placing the cursor over a soft button. The button is then depressed by placing the stylus into pressure. This may result in a function being performed upon the image directly or, alternatively, may result in an appropriate sub-menu being displayed so that appropriate control may be made in response to user input.

It can be appreciated that the working space displayed on monitor 301 has become somewhat complex if all available functions are to be displayed.

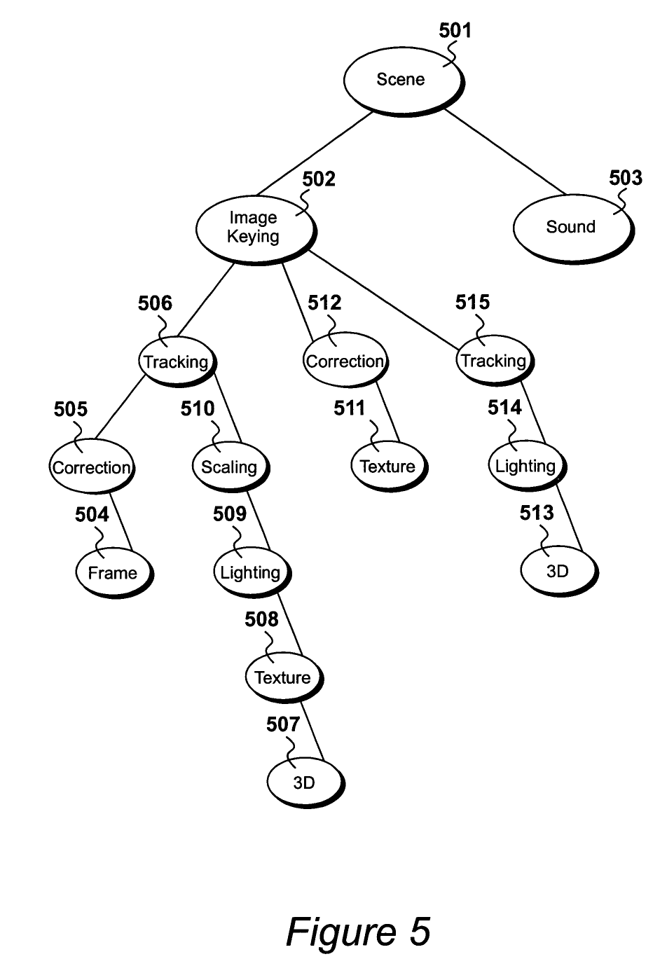

FIG. 5

The number of possible functions available to an artist has increased and there is a trend for more and more of these functions to be used concurrently to produce a particular effect. Furthermore, it is preferable for the nature of the functions to be stored as definitions or metadata whereafter their implementation takes place in real-time. Thus, the process of compositing etc requires many functions to be performed as part of a final rendering operation rather than partially processed work being stored and then processed again. Consequently, many functions may be required and in order to make modifications an artist is required to identify a particular function of interest.

In order to provide artists with a representation of the nature of a function being performed, the structure of the processing operations may be displayed as a process tree, as illustrated in FIG. 5. Process trees generally consist of sequentially linked processing nodes, each of which specifies a particular processing task required in order to eventually achieve an output in the form of a composited frame or video sequence. Traditionally, an output sequence 501 will comprise both image data and audio data. Accordingly, the composited scene will require the output from an image keying node 502 and the output from a sound mixing node 503. In this example, the image keying node 502 calls on a plurality of further processing nodes to obtain all the input data it requires to generate the desired image data, or sequence of composited frames. In the example, the desired output image data includes a plurality of frames within which a three-dimensional computer generated object is composited, as well as a background also consisting of a plurality of three-dimensional objects superimposed over a background texture.

The image keying node 502 requires a sequence of frames originating from node 504. Each frame undergoes a colour correction process at node 505 followed by a motion tracking process at a motion tracking process node 506. Modelled 3D objects are generated by a three-dimensional modelling node 507 and a texture is applied to these objects by a texturing node 508. After being textured, lighting is applied by an artificial light processing node 509, followed by a scaling operation performed by a scaling node 510. Tracking node 506 is then responsible for combining the computer generated object with the image frames. To generate the background, image processing node 502 also requires a uniform texture from a texturing node 511. Colour correction is applied to this texture by means of colour correction node 512 a further three-dimensional modelling node 513 generates further objects upon which lighting is applied by node 514 followed by tracking performed by node 515. Consequently, image keying node 502 may now composite the foreground objects with the background.

Each node illustrated in FIG. 5 will have an associated menu of controls allowing modifications to be made at that particular point in the overall image processing exercise. Thus, when modifications are made at the menu level, it is necessary for a database to be established so as to oversee the relationship between manual input commands being made and their associated node at which the modifications are to take effect. Thus, the complexity of images results in a greater requirement for the display of control menus so as to allow full control to be given to an artist during a compositing exercise. It will be appreciated that other methods of storing data associated with processing operations exist, and that the invention is not limited to image processing apparatus which operates in the way described herein.

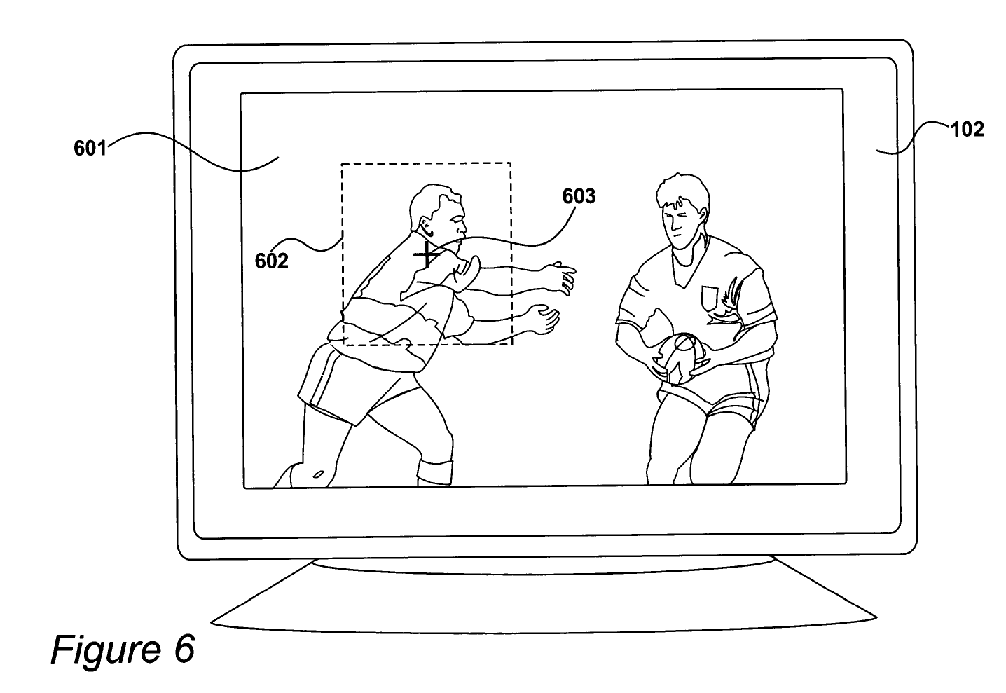

FIG. 6

Problems associated with the availability of free monitor space are made worse when the definition of images being processed is increased. FIG. 3 shows a prior art example of a standard television broadcast image being processed. However, as illustrated in FIG. 6, the present invention is particularly directed towards the processing of higher definition images such as images derived from cinematographic film. Thus, a high definition image has been loaded of a definition such that, when displayed, as illustrated in FIG. 6, the whole of the available display space of visual display unit 102 is used for displaying the image frames. Even with very large visual display units, it is recognised that artists must work with material at an appropriate definition so as to ensure that the introduction of visible artefacts is minimised. However, a problem with displaying images at this definition, as illustrated in FIG. 6, is that the monitor does not provide additional space for the display of menus alongside the displayed high definition images.

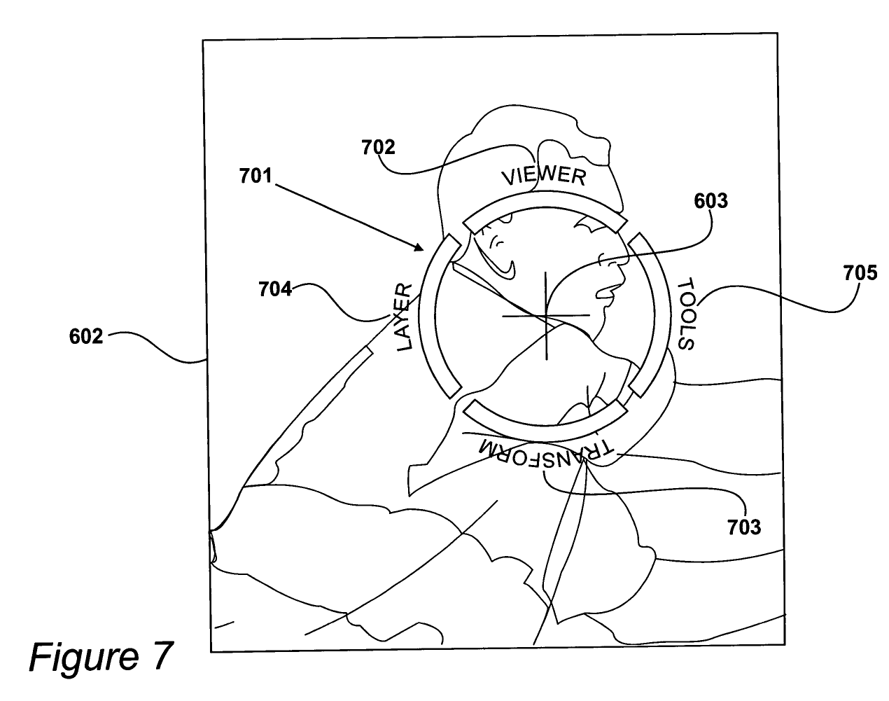

Region 602 of the high definition image 601 is shown enlarged in FIG. 7. A cursor 603 is shown in FIG. 6 at a selected position. After being placed in this selected position, an artist operates spacebar 106 of the keyboard 105 resulting in a selection device being displayed at the cursor 603 position. Clearly other ways of activating the selection device may be used apart from the space bar, for example other keys on the keyboard, a button on the stylus, and so on.

FIG. 7

A displayed selection device providing four selection regions, that have been identified as “gates”, is shown at 701 in FIG. 7. Each gate of the displayed device 701 identifies a function type and each of said function types has an associated displayable menu. After activating the spacebar, the selection device 701 is located around the position of the displayed cursor 603. The selection device 701 remains displayed after the space bar has been activated. A further activation of the space bar removes the device 701. In addition, device 701 is also removed if the stylus is activated so as to move the cursor 603 through one of the gates 702 to 705. Moving the stylus 103 in an upwards direction results in the displayed cursor 603 passing through the “viewer” gate 702. In response to passing the cursor 603 through the viewer gate 702, a viewer menu is displayed in an upper portion of the screen. Similarly, by moving the stylus 103 in a downward direction, the cursor 603 is passed through a tool control gate 703 (a transform in this example), identified as a transform tool in FIG. 7. By moving the stylus 103 to the left, the cursor 603 passes through a “layer” gate 704 resulting in an associated menu being displayed to the left of the image. Furthermore, by moving the stylus 103 to the right, the displayed cursor 603 is taken through the tools gate 705, resulting in an appropriate menu being displayed to the right of the image.

The particular function types available are relevant to the application being performed in the preferred embodiment. However, it should be appreciated that similar techniques may be used in different environments. Within the same application, it is possible that different views may be called is and one or more of said views may have an interface device relevant to that particular view. For example, a schematic view may be shown or a player view may be shown. Upon calling the interface device (by activation of the space bar) the interface device may be relevant to schematic operations when the schematic view is shown and may be relevant to player operations when the player view is shown. The schematic viewer displays the entire composition (that is to say the whole graph). The user usually has a node selected in the graph. When the user displays the schematic gate device it will preferably display the schematic starting from the current selection. This will show the user everything in the scene that generated the current selection and is therefore a filtered version of the schematic view.

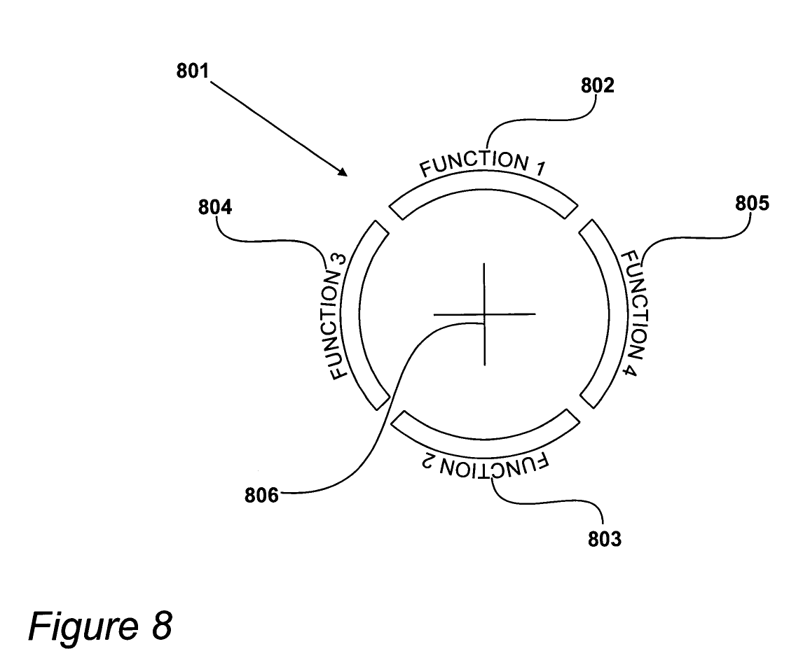

FIG. 8

An abstracted interface is illustrated in FIG. 8. In response to a first input command, an interface device 801 is displayed at a cursor 806 position. In this embodiment, this first input command consists of the spacebar of a keyboard being depressed. The interface device identifies a plurality of function types (802, 803, 804, 805) and by passing a cursor 806 through one of these function types, an appropriate menu is displayed Although the menu can be displayed in any part of the screen, it is preferably displayed at a location related to the gate through which the cursor has passed. Thus, if the cursor 806 moves to the left, preferably a left menu is displayed; if the cursor 806 moves to the right, preferably a right menu is displayed; if the cursor 806 moves upwards, preferably an upper menu is displayed; and if the cursor 806 moves downwards, preferably a lower menu is displayed.

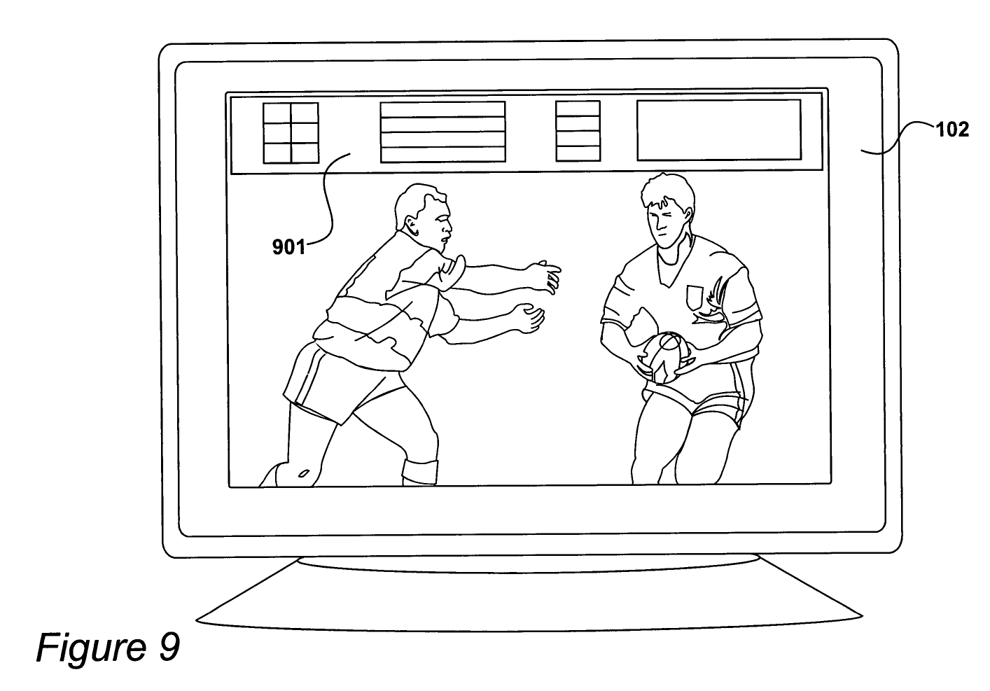

FIG. 9

In a preferred embodiment, movement of cursor 602 in response to stylus 103 in an upwards direction through gate 702 results in a movement of viewer gate menu 901 being displayed in an upper portion of the screen. The viewer gate menu is used to set viewer specific options such as render pre-sets for three-dimensional players or filtering for schematics. The viewer menu relates directly to the viewer in focus and the name of the viewer in focus preferably appears in the gate user interface. The displayed menu takes up the same width as a tool panel user interface and it is locked to the top of the user interface regardless of how many viewers are present. The panel is fully opaque and sits over all other panels. Upon leaving the viewer menu the menu itself disappears thereby returning the full screen to the image under consideration.

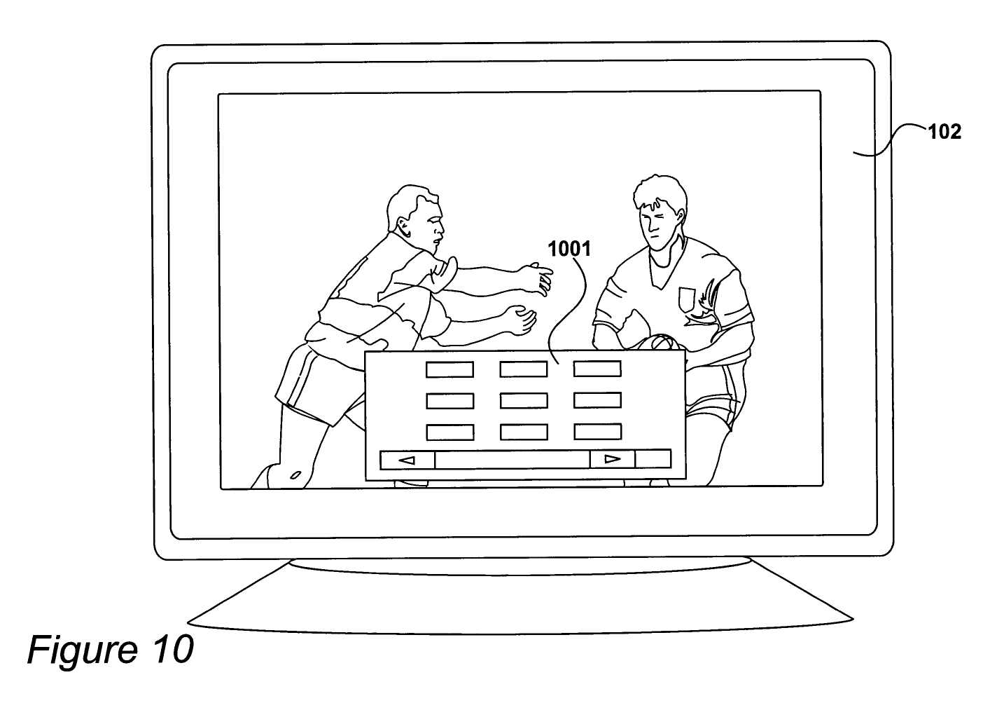

FIG. 10

Moving the cursor 602 in a downward direction, through gate 703, results in a current tool menu 1001 (a transform in this example) being displayed in a lower region of the screen of monitor 102. The current tool menu is used to interact with the current tool. Gate 703 is only available if one tool has been selected. Thus, the gate relates directly to the current tool under consideration. The name of the current tool preferably appears in the gate user interface. The menu is locked to the bottom of the player in focus and use is also made of the transport tool user interface.

After use has been made of the current tool menu, the menu is removed by activating spacebar 106 again, thereby making the whole screen available for the whole image. Activation of an “escape” has a similar effect.

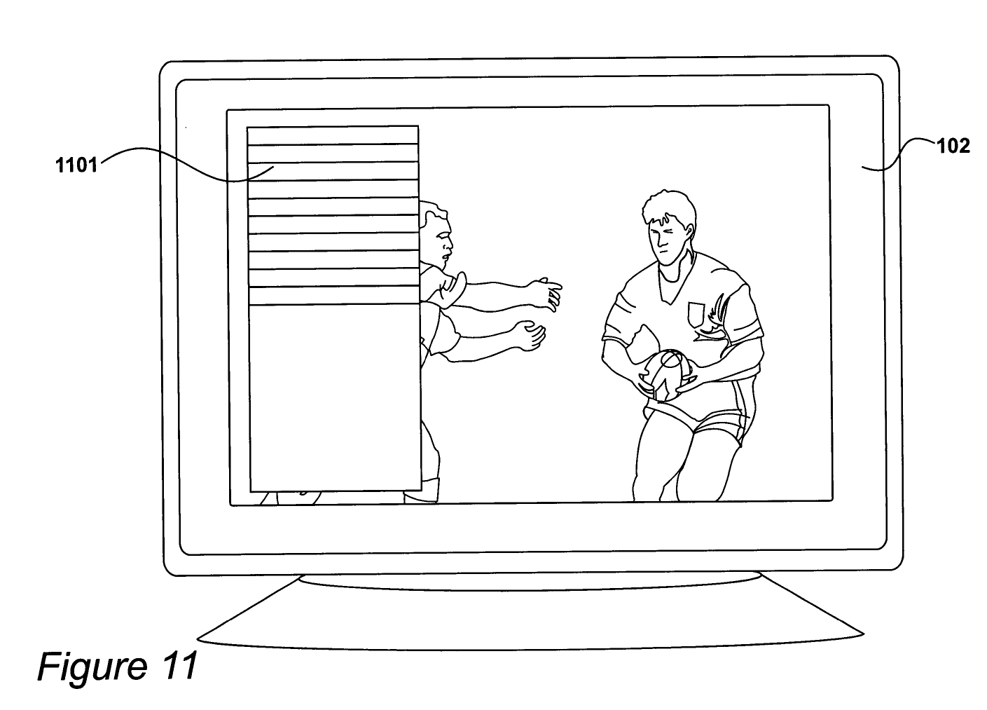

FIG. 11

Upon moving cursor 602 in a leftward direction through gate 704, a layer gate menu 1101 is displayed. The layer menu is used to select layers and the layer user interface takes up the same width as a layer list. It is locked to the left side of the user interface regardless of how many viewers are present. The panel is fully opaque and sits over all other panels. The layer gate menu 1101 only contains details of the layers; the layer list is not expandable and there is no value column. A user can set whether a layer is visible or not visible and the layer menu 1101 disappears after the cursor exits to a new area.

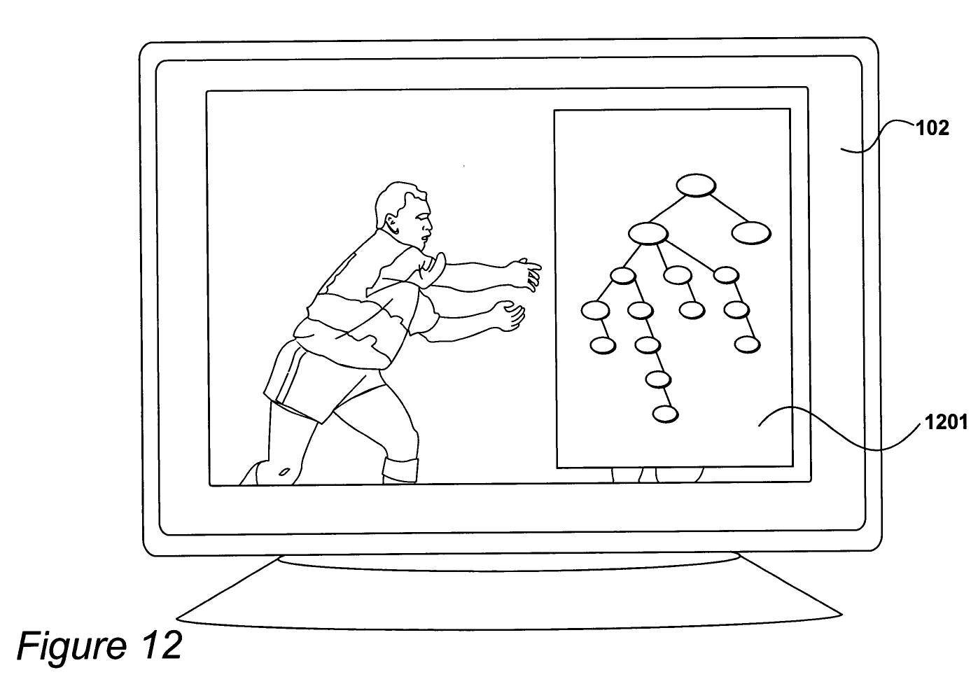

FIG. 12

Upon moving cursor 602 in a rightwards direction through gate 705 tools menu 1201 is displayed. The tools menu is used to select the current tool and is only available when only one layer has been selected. The tools gate menu takes up the same width as the layer list and is locked to the right side of the interface regardless of how many viewers are present. The panel is fully opaque and sits over all other panels. The tools menu 1201 contains a filtered version of the schematic showing only the tools associated with a selected object. The menu disappears after the cursor has been moved out of the menu area. It should be appreciated that these particular menu selections are purely an application of the preferred embodiment and many alternative configurations could be adopted while invoking the inventive concept.

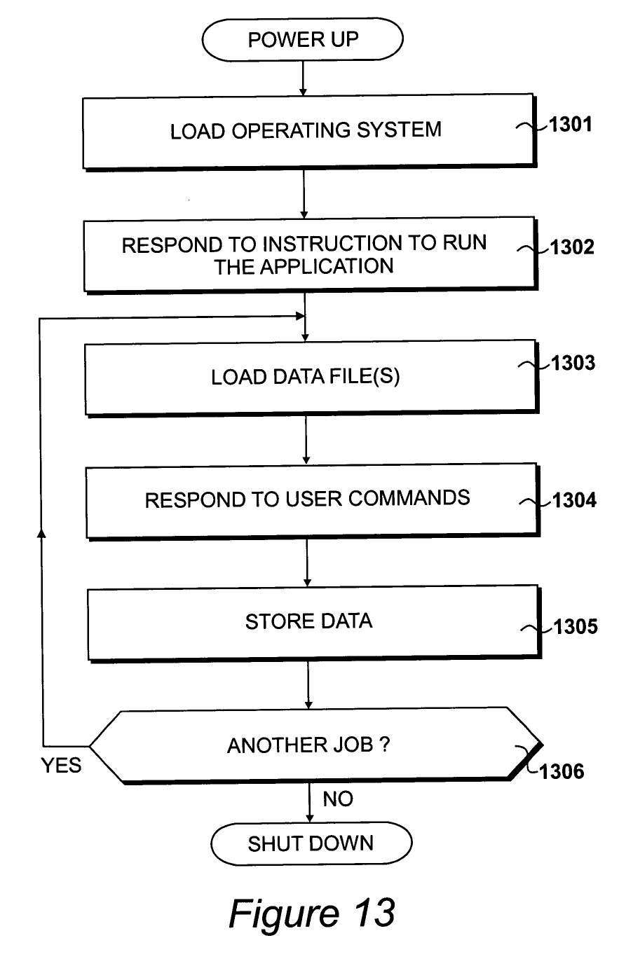

FIG. 13

Operations performed by the processing unit 202 in order to provide the functionality described with reference to FIGS. 6 to 12 is identified in FIG. 13. After power-up an operating system is loaded at step 1301 whereafter at step 1302 the system responds to instructions from a user to run the compositing application.

At step 1303 data files are loaded and at step 1304 the application operates in response to commands received from a user. At step 1305 newly created data is stored and at step 1306 a question is asked as to whether another job is to be processed. When answered in the affirmative, control is returned to step 1303 allowing new data files to be loaded. Alternatively, if the question asked at step 1306 is answered in the negative, the system is shut down.

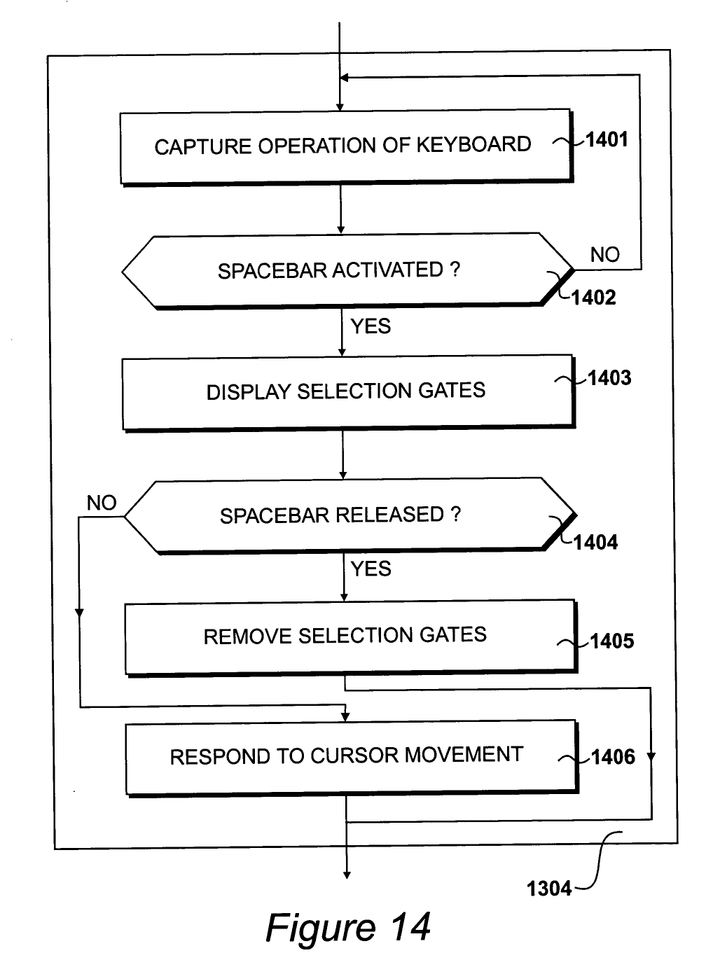

FIG. 14

Procedures 1304 relevant to the present preferred embodiment are illustrated in FIG. 14. At step 1401 a keyboard operation is captured and at step 1402 a question is asked as to whether the spacebar has been activated. If answered in the negative, control is returned to step 1401 else control is directed to step 1403.

In response to the spacebar being activated and detected at step 1402, selection gates 701 are displayed at step 1403. At step 1404 a question is asked as to whether the spacebar has been released and if answered in the affirmative, the selection gates are removed. Alternatively, if the question asked at step 1401 is answered in the negative, control is directed to step 1406 such that the application responds to further cursor movement.

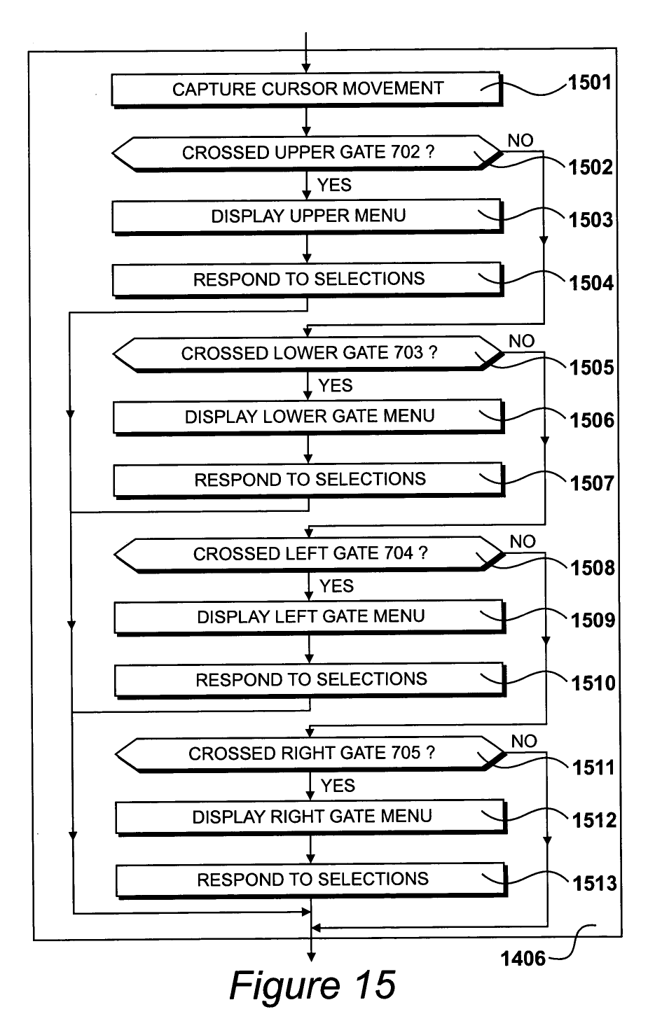

FIG. 15

Procedure 1406 is detailed in FIG. 15. At step 1501 cursor movement is captured and at step 1502 a question is asked as to whether the cursor has moved across the upper gate 702. If answered in the negative, control is directed to step 1505, but if answered in the affirmative the upper menu (the viewer menu in the preferred embodiment) is displayed at step 1503 and the system responds to menu selections made at step 1504.

At step 1504 a question is asked as to whether the cursor has crossed the lower gate 703 and if answered in the negative control is directed to step 1508. If answered in the affirmative, to the effect that the cursor did cross the lower gate 703, the lower gate menu (selected tool menu in the preferred embodiment) is displayed at step 1506 and responses to selections are made at step 1507.

At step 1508 a question is asked as to whether the cursor has crossed the left gate 704 and if answered in the negative control is directed to step 705. In answered in the affirmative, the left gate menu (the layer menu in the preferred embodiment) is displayed at step 1509 and responses to selections are made at step 1510.

At step 1511 a question is asked as to whether a cursor has crossed the right gate 705. If answered in the affirmative, the right gate menu (the tools menu in the preferred embodiment) is displayed at step 1512 and the system responds to manual selections at step 1513.

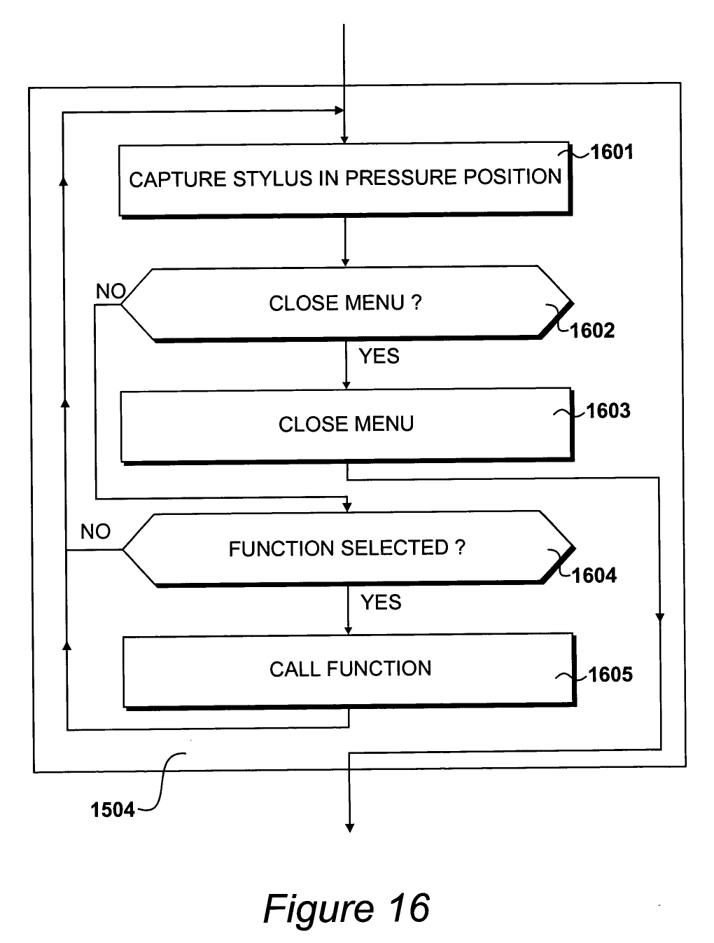

FIG. 16

Procedures 1504 for responding to input selections are detailed in FIG. 16. At step 1601 a position is captured when the stylus 103 is placed in pressure.

At step 1602 a question is asked as to whether a menu has been closed, either as a result of a “close menu” button being operated or, for certain menus, whether the stylus has been taken outside the menu area. If answered in the affirmative, the menu is closed at step 1603.

If the question asked at step 1602 is answered in the negative, a question is asked at step 1604 as to whether a function has been selected. If answered in the affirmative, the function is called at step 1605.

Procedures 1507,1510 and 1513 are substantially similar to procedures 1504 shown in FIG. 16.

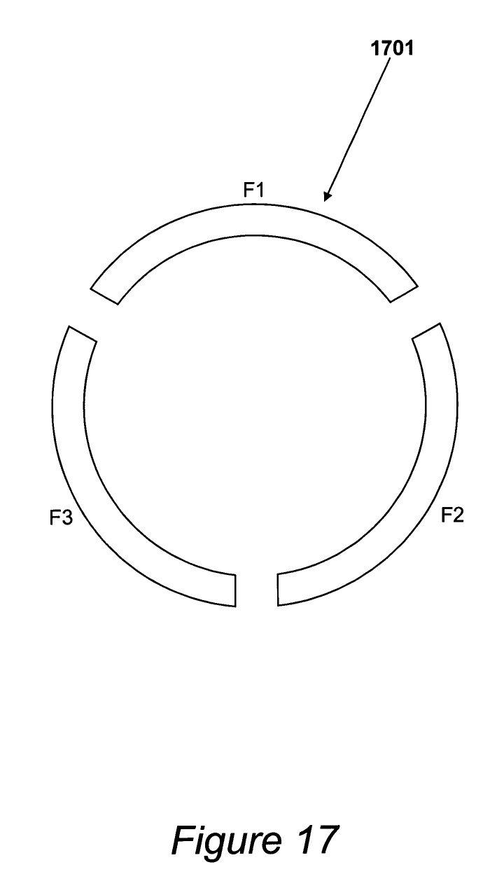

FIG. 17

An alternative embodiment is illustrated in FIG. 17. Instead of the substantially circular device being divided into four sections, allowing four function menus to be selected, a circular device 1701 is divided into three sections from which three function devices may be selected.

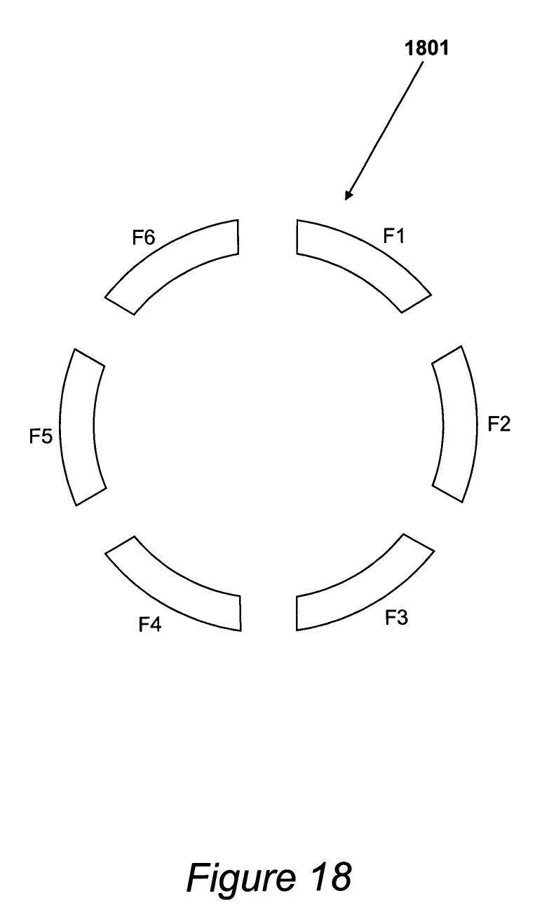

FIG. 18

A further alternative embodiment is illustrated in FIG. 18 in which a substantially circular device 1801 has been divided into six sections allowing six functional menus to be selected. In the preferred embodiments disclosed herein, the selection device has a substantially circular shape. It should also be appreciated that other shapes, such as quadrilaterals etc may be adopted as an alternative.

What we claim is:

1. Apparatus for processing image data, comprising processing means, storage means, display means and stylus-like manually operable input means, wherein
said processing means is configured to perform functions upon image data in response to an operator manually selecting a function from a function menu;
said processing means responds to a first user-generated input command so as to display a plurality of function gates at a cursor position;
movement of the stylus-like manually operable input means so as to move said cursor through one of said function gates results in a related menu being displayed; and
manual selection of a function from said displayed menu results in the selected function being performed upon said image data.

2. Apparatus according to claim 1, wherein said manually operable input means is a stylus and a touch-tablet combination.

3. Apparatus according to claim 1, wherein a first user-generated input command is generated in response to keyboard operation.

4. Apparatus according claim 3, wherein said keyboard operation involves activation of a spacebar.

5. Apparatus according to claim 1, wherein four function gates form a substantially circular device.

6. Apparatus according to claim 1, wherein six function gates form a substantially circular device.

7. Apparatus according to claim 1, wherein the function gates form a substantially quadrilateral device.

8. Apparatus according to claim 1, wherein said menus relate to functions applicable to image data processing.

9. Apparatus according to claim 8, wherein said image data processing functions relate to compositing and editing image frames.

10. A method of selecting a function via a graphical user interface for receiving input commands, wherein
in response to a first input command, a selection device is displayed at a cursor position;
said selection device identifies a plurality of function types at selected positions, each having an associated displayable menu;
in response to a second input command, a cursor is moved over one of said positions; and
having moved the cursor over a function type position the aforesaid menu associated with said position over which the cursor has been moved is displayed.

11. A method according to claim 10, wherein a first selection device or a second selection device is displayed dependent upon the current state of operations being performed by an operator.

12. A method according to claim 11, wherein a schematic-related device is displayed when the operator is using a schematic view and a player-related device is displayed when an operator is viewing a player view.

13. A method of supplying input data to a computer system, comprising the steps of
issuing a first input command to call up a graphical user interface in which a plurality of gates surround a cursor position; and
in response to a second input command, moving said cursor through one of said gates; and
supplying input data determined by which of said gates the cursor is moved through.

14. A method according to claim 13, wherein four gates are displayed in said graphical user interface in a substantially circular configuration.

15. A computer-readable medium having computer-readable instructions executable by a computer such that, when executing said instructions, said computer will perform the steps of:
responding to a first user-generated input command so as to display a plurality of function gates at a cursor position;
responding to movement of manually operable input means so as to move said cursor through one of said function gates and displaying a menu in response to said cursor movement; and
responding to manual selection of a function from said displayed menu so as to perform said function upon image data.

16. A computer-readable medium having computer-readable instructions according to claim 15, wherein said cursor moves thru one of said function gates in response to manual operation of a stylus upon a touch-tablet.

17. A computer-readable medium having computer-readable instructions according to claim 14, such that when executing said instructions a computer will display four function gates that define a substantially circular shape.

18. A computer-readable medium having computer-readable instructions according to claim 15, such that when executing said instructions a computer will display a menu at a screen position related to the relative positions of its respective gate.
